(19) United States
(12) Patent Application Publication
(10) Pub. No.: US 2010/0250937 A1
(43) Pub. Date: Sep. 30, 2010

(54) Method And System For Securely Caching Authentication Elements

(75) Inventors: Scott A. Blomquist, Portland, OR (US); Chad Blomquist, Portland, OR (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(73) Assignee: Vidoop, LLC, Portland, OR (US)

(21) Appl. No.: 12/530,263

(22) PCT Filed: Mar. 5, 2008
(86) PCT No.: PCT/US2008/055886

§ 371 Date: Jun. 11, 2010

Related U.S. Application Data
(60) Provisional application No. 60/893,001, filed on Mar. 5, 2007.

(51) Int. Cl. H04L 9/32; H04L 9/06

(52) U.S. Cl. 713/170; 380/277; 713/168

(57) ABSTRACT

A system and method for authorizing a user to a plurality of secure servers. Each server is adapted to store user information. The secure server receives a request for access to one of the plurality of secure servers from a first user device from a user possessing an authorized account identifier. An authentication server may intervene and request the user authenticate to the authentication server and transmit a client-side electronic lockbox stored at the first user device to the authentication server. The authentication server retrieves a key′ corresponding to the received client-side lockbox and uses the key to decrypt an encrypted file contained within the lockbox. The decrypted file may contain authentication information that is forwarded to the secure server. The secure server grants the user access to the user's content stored thereon when the authentication information received from the authentication server corresponds to the authentication information stored at the secure server for the user. The present method provides the user the ability to manage access to the user's content by permitting the user to delete or disable a client-side lockbox or associated key from a remote location.

### CROSS REFERENCE TO RELATED APPLICATIONS

This application claims priority of U.S. Provisional Patent Application No. 60/893,001, filed Mar. 5, 2007, the contents of which are incorporated fully herein by reference.

### FIELD OF THE INVENTION

The present invention is directed to a method and system of authenticating identity to a secure computer system. In particular, the present invention is directed to the secure caching of authentication elements stored at the user's devices and used to access the secure computer system.

### BACKGROUND OF THE INVENTION

Computer networks, particularly those with global reach such as the Internet, have greatly influenced the way that individuals, companies and institutions conduct transactions, and store and retrieve documents, images, music, and video. Convenience, ease of use, speed, and low overhead costs are contributing factors to the widespread use of the Internet for purchasing goods as well as conducting confidential transactions. Entire industries have emerged as a result of the evolution of the Internet.

Secure access to computer systems and computer networks has been traditionally guarded with a username and password pair. This requires the user to protect the username and password from unauthorized use. If the username and password are not protected, accounts and files can be compromised. Unfortunately, a number of rogue individuals and organizations have emerged that are dedicated to fraudulently obtaining confidential information for unauthorized or criminal activities.

A pervasive tool used in obtaining confidential information is keystroke-logging software, which constitutes a program that monitors and records what users type on their computers. Such software often comprises the payload of viruses, worms, Trojan horses, and other forms of malware. Keystroke-logging software can reveal what a user is typing on a computer without the user's knowledge of this event occurring.

Companies and institutions routinely use keystroke-logging software to monitor employee activity. Also, families may use these types of programs to monitor children's online activities. The widespread availability of this type of software, however, has lead to unauthorized or criminal use, resulting in the alarming rate of identity theft seen throughout the world. Prime targets for these attacks arc financial institutions, as more and more consumers and businesses use electronic methods for purchasing and making payments.

Login information may also be “heard” by sophisticated analysis of the distinct sounds made by different keys. An inexpensive microphone near a keyboard can reveal most of what is being typed with a surprising degree of accuracy (http://www.schneier.com/blog/archives/2005/09/snooping_on_tex.html).

Login information is also vulnerable to simple spying or “shoulder-surfing”, as a person with malicious intent watches an unsuspecting user sign into his or her account. The present invention employs a method that significantly reduces the likelihood of a successful shoulder-surfing style of attack.

Additional security mechanisms are necessary in addition to the username/password paradigm to provide stronger identity authentication. There have been various other attempts to do so.

Enterprises and institutions have implemented costly physical devices to identify legitimate customers and users. The existing devices generate a unique pass code for each user every 30 to 60 seconds. If an attacker manages to intercept a user ID and password, the information cannot be used to access the site without an additional authentication identifier displayed by the device. The devices significantly reduce instances of identity or information theft, but present challenges for both the institutions and individual users.

The enterprise may meet with consumer resistance in implementing use of the physical device. If the user does not have the device, he or she cannot gain access to the site. Besides the tremendous initial cost of purchasing the physical devices and implementing the new system, if the device is lost, stolen, or damaged, the enterprise will incur even more significant costs. In the context of business use of the device, the company incurs the cost of lost productivity from a worker who cannot access company information, as well as the cost of replacing the actual device. In the context of consumer use, if the consumer cannot access his or her accounts because of a lost device, the direct costs, and more significantly the indirect costs incurred by the enterprise to assist the consumer in gaining access far outweighs the advantages of using the device system.

Because of these noted shortcomings, there remains a need for improved systems and methods for protecting information accessible from remote locations via a secure computer network while maintaining case of use.

### SUMMARY OF THE INVENTION

The present invention provides an authentication method for authorizing a user to a plurality of secure servers. Wherein each secure server is adapted to store user information. The method comprises receiving a request for access to one of the plurality of secure servers from a first user device using an authorized account identifier. A request for the user to authenticate to an authentication server is transmitted and an encrypted file stored by the user is received from the first user device. A key specific to the first user device is retrieved and selected from a plurality of keys associated with the account identifier upon authentication of the user to the authentication server and receipt of the encrypted file. Each key corresponds to one of a plurality of user devices. The encrypted file is decrypted with the key to generate a decrypted file containing an authentication element. The secure server is accessed using the authentication server to transmit the authentication element and account identifier and access is granted to the secure server if the transmitted authentication element and account identifier corresponds to a stored authentication element and account identifier for the user.

The present invention further provides a system for authorizing a user to a secure server. The system comprises a means for authenticating the user to the secure server, a user device, and an authentication server. The means for authenticating the user to the secure server authenticates the user upon receipt of an authorized account identifier and a corresponding authentication element. The user device comprises a means for storing a client-side lockbox containing the authentication element. The authentication server is communicatively connected to the secured computer system. The authentication server is adapted to store a plurality of keys corresponding to the authorized account identifier. At least one of the plurality of keys is specific to the user device. When the user attempts to access the secure server the authentication server intervenes and requires transmission of the account identifier and client-side lockbox to authenticate the user to the authentication server. Wherein upon authentication to the authentication server and receipt of the client-side lockbox the authentication server retrieves the key corresponding to the account identifier and the user device used to access the authentication server. The authentication server opens the client-side lockbox using the key specific to the user device and transmits the account identifier and the authentication element contained in the client-side lockbox to the means for authenticating the user to the secure server.

The present invention further comprises a method for authorizing a user to a secure server adapted to store user information. The method comprises receiving a request for access from a first user device. Transmitting a request for the user to authenticate to an authentication server. Receiving an encrypted file stored by the user from the first user input device. Retrieving a key specific to the first user device selected from a plurality of keys associated with the user upon authentication of the user to the authentication server and receipt of the encrypted file. Decrypting the encrypted file to generate a decrypted file containing an authentication element. The authentication server transmits the decrypted file comprising the authentication element to the secure server. The secure server grants the user access if the transmitted authentication element corresponds to a stored authentication element for the user.

Further still, the present invention is directed to a method for granting a user access to a secure computer system. The method comprises establishing a communications channel between the secure computer system and a first user device. An account identifier and a password are received from the first user device via the communications channel. A query is generated and transmitted from the secure computer system to the user to request an authentication element containing an encrypted code specific to the first user device and the account identifier. A key stored by the computer system is retrieved upon receipt of the authentication element. The key is specific to the first user device and account identifier and is adapted to allow decryption of the encrypted code. Access to the secure computer system is granted only if the encrypted code received from the first user device, when decrypted with the key, corresponds to the account identifier and first user device.

### BRIEF DESCRIPTION OF THE DRAWINGS

FIG. 1 illustrates a simplified flowchart diagram of an enrollment process used in connection with the present invention directed to secure caching of a user authentication element.

FIG. 2 is a flow chart diagram of a preferred embodiment in accordance with the present invention showing an authentication routine using a secure authentication element in accordance with the present invention.

FIG. 3 is a diagrammatic representation of an environment within which the present invention may function.

### DETAILED DESCRIPTION

The present invention is directed to a method for securely storing information on a computer for future retrieval using a remote service which requires a user specific cryptographic key for each device used to access the computer system. The present invention requires the user of a secure computer system to provide an authentication credential in addition to the traditional username/password pair authentication credentials required by many secure systems in use today. In accordance with the present invention, the additional authentication credential is an encrypted file comprising a unique authentication element that is specific to the user's account and the device from which the user is attempting to access its account.

Upon attempting to access his or her secure account the user is required to provide an authentication server with a client-side lockbox stored at the user's device. The client-side lockbox contains an encrypted authentication element specific to the user's device and the user's account. The user is granted access to the secure computer system if the contents of the client-side lockbox, provided by the user, match the contents stored by the authentication server. One skilled in the art will appreciate that the methods of authentication described herein may be used in conjunction with the graphical user interface described in U.S. patent application Ser. No. 29/276,601 filed Jan. 30, 2007, entitled “Graphical User Interface” and the authentication methods described in U.S. patent application Ser. No. 11/420,061 filed May 24, 2006, entitled “Graphical Image Authentication and Security System” both of which are incorporated herein by reference.

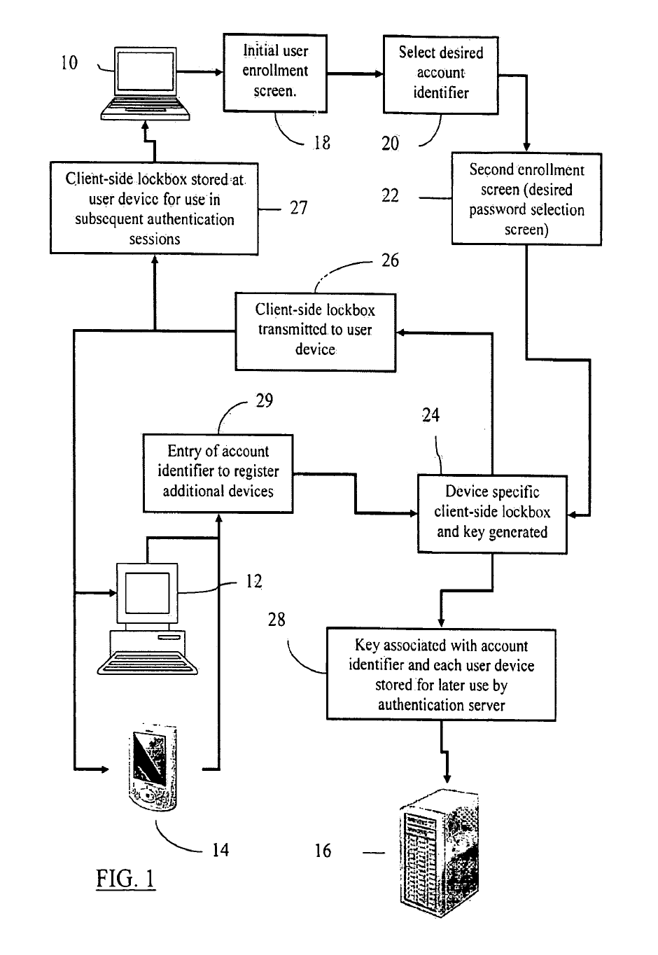

Referring now to the figures in general and specifically to FIG. 1, there is shown therein a simplified flow chart diagram of an initial enrollment process in order to enroll a plurality of user devices 10, 12, and 14 to utilize the present invention. As used herein “user device” may mean a personal computer having a central processing unit, a keyboard or other input device and monitor; a personal digital assistant; a cellular mobile telephone; or other device. During enrollment, the user attempts to access the authentication server 16 and is presented with an initial enrollment screen in at Step 18 where a desired account identifier is entered at Step 20. As used herein the term “account identifier” may comprise an alphanumeric string of characters forming a username used to identify the user to the authentication server 16. The authentication server 16 receives the desired account identifier and checks its availability. In the event the desired account identifier is already in use, the authentication server 16 may generate a request for the user to select a different account identifier. This process may be repeated until the user has selected a unique account identifier.

After the account identifier is granted, a second enrollment screen may be presented (Step 22) to select an authentication element for the system. It will be appreciated by one of skill in the art that the user may also be required to select a traditional password formed from a string of alphanumeric characters to allow initial access to the authentication server 16 for a purpose to be described hereinafter. The account identifier, authentication element and optional password are stored by the authentication server 16 and a user device specific client-side lockbox and key are generated Step 24. The client-side lockbox comprises the authentication element and a serial number used to identify the respective user device 10, 12 or 14. In accordance with the present invention, the authentication element may be encrypted using one of many known encryption methods. The client-side lockbox is transmitted (Step 26) to the first user device 10 and stored (Step 27) at the user device for use in subsequent authentication sessions.

The key generated by the authentication server 16 is associated with the user's account identifier, assigned the serial number specific to the user device 10 and stored in a database (not shown) (Step 28) accessible by the authentication server for later use by the server.

The user may subsequently register additional user devices such as a work computer 12 or an Internet equipped cellular phone 14. To register such devices the user attempts to access its account information at the authentication server 16 from the device he or she desires to register.

Once logged in to the authentication server, the user may request to register the new device and the new client-side lockbox, unique to the alternative user device 12 or 14 is generated and transmitted to the appropriate user device (Step 29). The user's account information is then updated at the authentication server and the new key generated (Step 24), which corresponds to the newly generated client-side lockbox, is associated with the user's account identifier and transmitted to the user's device (Step 26). Thus, the user may have multiple keys and client-side lockboxes associated with a single account identifier. However, as discussed hereinafter, the user may use any of the client-side lockboxes to access its secure information present at a service provider's server via the authentication server. As will now be understood, the present invention allows the user to access the plurality of keys stored at the authentication server 16 and delete a device specific key should the user lose one of its devices to prevent access to the user's information from the specific device while permitting access from the devices still under the user's control.

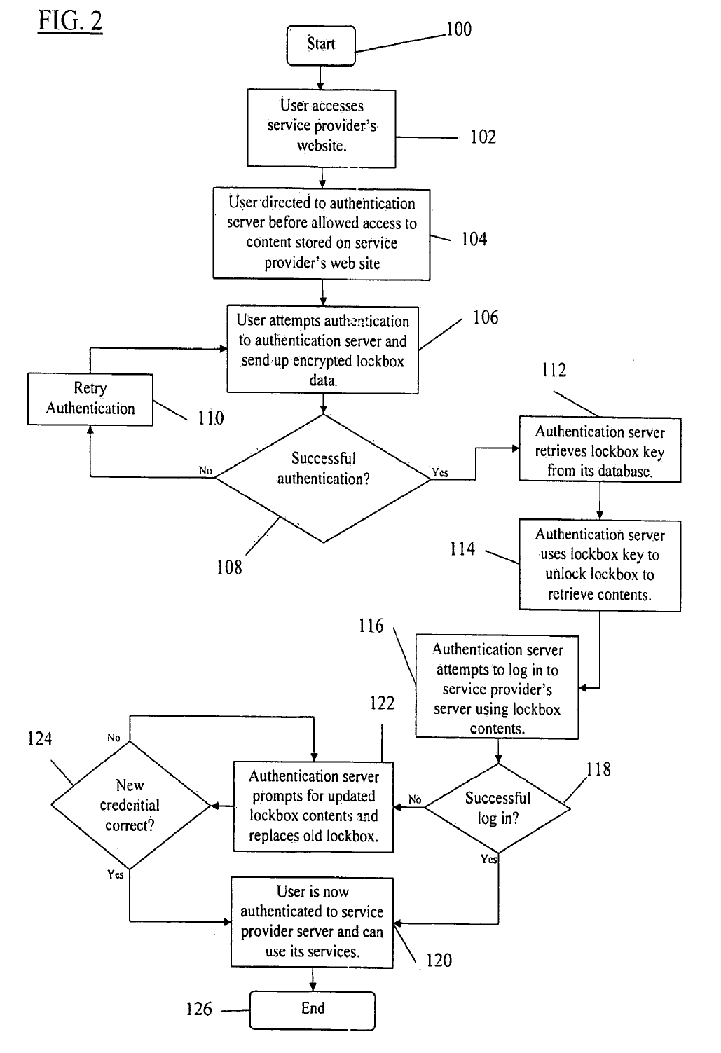

Turning now to FIG. 2, there is shown therein a method for authentication of a user to a secure service provider server subsequent to the enrollment process shown in FIG. 1. At step 100 the process starts and the user attempts to access a secure service provider's server at step 102. Upon attempting to access the service provider's web server, the user is directed to an authentication server (Step 104) to authenticate the identity of the user before allowing access to the content stored on the service provider's server.

At Step 106 the user attempts authentication to the authentication server and sends its encrypted lockbox data from the user's device to the authentication server. It will be appreciated that the user may provide conventional authentication information such as a user name and password at Step 106 in addition to the encrypted lockbox data. Additionally, the user may be authenticated to the authentication server in a manner described in co-pending U.S. patent application Ser. No. 11/420,061. If authentication to the authentication server is unsuccessful (Step 108) the user may retry authentication at Step 110 or the authentication server may lockout the user's account until authentication by other means can be accomplished.

If authentication to the authentication server is successful (Step 108) the authentication server will retrieve the specific key corresponding to the user's lockbox from a database accessible by the authentication server (Step 112). The authentication server opens the lockbox using the retrieved key to retrieve or decrypt the lockbox's contents (Step 114). At step 116 the authentication server will attempt to log-in to the service provider's server using the decrypted contents of the lockbox. The contents of the lockbox may include any item of information or authentication parameter that may be used to authenticate the user to the service provider's server. The lockbox contents may include an authentication element such as, but not limited to, the user's name, password, an encryption key, or a biometric authentication parameter.

If log-in is successful (Step 118), the user is authenticated to the service provider's server and able to use its services or access information stored thereon (Step 120). However, if log-in is not successful, the authentication server will prompt the user to provide updated lockbox contents and replace the old lockbox stored on the device from which the user is attempting to access the service provider's server (Step 122). The authentication server 16 (FIG. 1) then attempts to log-in to the service provider's server using the new credential. If the new credential is correct (Step 124), the user is logged into the server (Step 120) and the authentication process ends (Step 126). In the event the new credential is not correct (Step 124) the authentication server may prompt for updated lockbox contents again (Step 122) or optionally lockout the user from accessing the service provider's server.

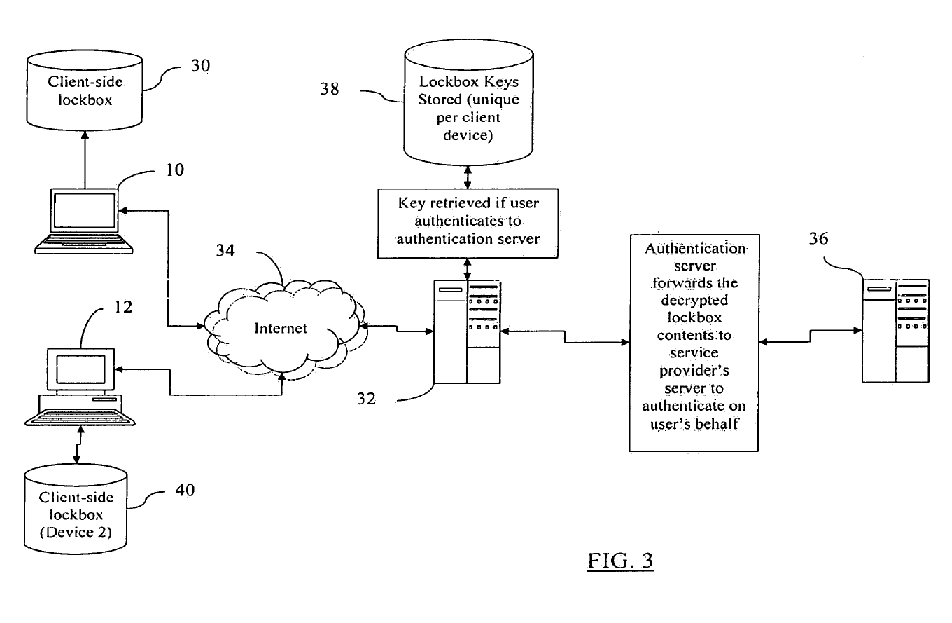

With reference now to FIG. 3, there is shown therein a diagrammatic representation of the general environment in which the present invention operates. FIG. 3 shows a user device 10 adapted to store a client-side lockbox 30. The user's device 10 may be connected to an authentication server 32 via the Internet 34. The authentication server 32 may be communicatively connected to the service provider's secure server 36 and adapted to store a plurality of keys 38 corresponding to the authorized account identifier.

When the user attempts to access a service provider's secure server 36 via a first communications channel such as the internet 34, the authentication server 36 intervenes and queries the user to require transmission of the user's account identifier and client-side lockbox to authenticate the user to the authentication server. The authentication server 32 will require the user to successfully authenticate its identity and the user's device to the authentication server before allowing the user access to the service provider's secure server 36. This authentication methodology may include the use of a username and password and may add the feature of requiring the user to provide an additional unique authentication parameter such as an image identifier as described in co-pending U.S. patent application Ser. No. 11/420,061.

The authentication server 32 uses the encryption key to open the client-side lockbox 30 transmitted from the user's device 10, unlocks the lockbox, decrypts the information therein and forwards the decrypted lockbox contents to the service provider's server 36 to authenticate the user to the service provider's server 36. Upon successful authentication to the service provider's server 36, the user is allowed to access the data or services provided by the server.

The present invention may also include a method for permanently destroying all or one of the user's lockbox keys 38. Such destruction may he accomplished by the authentication server 32 upon the occurrence of multiple authentication failures or upon loss, theft, or compromise of one of the user's devices 10. Additionally, the user may delete the lockbox 30 or 40 from one of the user's devices 10 or 12 and instruct the authentication server 32 to destroy the corresponding lockbox keys upon the user's command. Accordingly, access to the user's stored content from the specific machine is effectively locked-down until otherwise authorized by the user.

The present invention is further directed to a method for authorizing a user to a secure server 36 adapted to store user information. The method comprises receiving a request for access from an authorized account identifier and transmitting a request for the user to authenticate to the authentication server 32. The client-side lockbox 30, comprising the encrypted file, stored by the user is transmitted from the user input device 10 to the authentication server 36. A key is retrieved from a plurality of keys stored by the authentication server database upon receipt of the client-side lockbox. The lockbox contents are then decrypted to generate a decrypted tile containing the authentication element. The service provider's secure server 36 is accessed using the authentication server to transmit the decrypted file and account identifier. Access is granted to the secure server if the decrypted authentication element and account identifier correspond to the secure server's stored authentication element and account identifier.

With reference to FIGS. 2 and 3, the present invention is further directed to a method for granting a user access to a secure computer system 36. The method comprises establishing a communications channel 34 between the secure computer system and the first user device 10. It will be appreciated by one skilled in the art that the functions discussed herein as performed by the authentication server may also be performed by a server functioning within the service provider's secure computer system without departing from the spirit of the present invention. The user transmits the account identifier and a password from the first user device via the communications channel 34 to the authentication server 32. The authentication server generates and transmits a query from either the authentication server 32 or the secure computer system 36 to the user to request an authentication element containing an encrypted code specific to the first user device 10 and the account identifier.

The key 38 is retrieved and used to decrypt the encrypted code received from the first user device. Access is granted to the secure computer system only if the encrypted code, when decrypted, corresponds to the account identifier and the first user device.

The method of the present invention further includes permitting the user to destroy the plurality of keys stored at the authentication server to prevent unauthorized access to the user's content stored across a plurality of secure servers. Thus, as previously discussed, the user is able to login to the authentication server from a remote location or unregistered device and either disable or destroy the plurality of keys stored therein and further to disable any one or all of the client-side lockboxes residing on the user's devices in the event of loss or theft of any of the user's devices.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that the invention may be practiced otherwise than as specifically illustrated and described.

What is claimed is:

1. An authentication method for authorizing a user to a plurality of secure servers each adapted to store user information, the method comprising:
receiving a request for access to one of the plurality of secure servers from a first user device using an authorized account identifier;
transmitting a request for the user to authenticate to an authentication server;
receiving an encrypted file stored by the user from a first user device;
retrieving a key specific to the first user device and selected from a plurality of keys associated with the account identifier upon authentication of the user to the authentication server and receipt of the encrypted file, wherein each key corresponds to one of a plurality of user devices;
decrypting the encrypted file with the key to generate a decrypted file comprising an authentication element;
accessing the secure server using the authentication server to transmit the authentication element and account identifier; and
granting access to the secure server if the transmitted authentication element and account identifier corresponds to a stored authentication element and account identifier for the user.

2. The method of claim 1 further comprising a plurality of user devices, each user device having an encrypted file thereon for accessing at least one of the plurality of secure servers, the method further comprising granting the user access to the authentication server and permitting the user to destroy the plurality of keys to prevent access to data stored in the plurality of encrypted files on the plurality of user devices and to prevent access to the plurality of secure servers using the user's account identifier.

3. The method of claim 1 wherein the authentication element comprises a password.

4. The method of claim 1 wherein the account identifier comprises a username.

5. A system for authorizing a user to a secure server, the system comprising:
a means for authenticating the user to the secure server upon receipt of an authorized account identifier and a corresponding authentication element;
a user device comprising a means for storing a client-side lockbox containing the authentication element
an authentication server communicatively connected to the secured computer system, wherein the authentication server is adapted to store a plurality of keys corresponding to the authorized account identifier, wherein at least one of the plurality of keys is specific to the user device; and
wherein when the user attempts to access the secure server the authentication server intervenes and requires transmission of the account identifier and client-side lockbox to authenticate the user to the authentication server;
wherein upon authentication to the authentication server and receipt of the client-side lockbox the authentication server retrieves the key corresponding to the account identifier and the user device used to access the authentication server;
wherein the authentication server opens the client-side lockbox using the key specific to the user device and transmits account identifier and the authentication element contained in the client-side lockbox to the means for authenticating the user to the secure server.

6. The system of claim 5 wherein the authentication element comprises an encoded alphanumeric code decoded using the key.

7. The system of claim 5 wherein the secure server comprises a web-based application server.

8. The system of claim 5 wherein the authentication server comprises a third-party authentication component.

9. A method for authorizing a user to a secure server adapted to store user information, the method comprising:
receiving a request for access from a first user device;
transmitting a request for the user to authenticate to an authentication server;
receiving an encrypted file stored by the user from the first user input device;
retrieving a key specific to the first user device selected from a plurality of keys associated with the user upon authentication of the user to the authentication server and receipt of the encrypted file
decrypting the encrypted file to generate a decrypted file comprising an authentication element;
accessing the secure server using the authentication server to transmit the decrypted file comprising the authentication element; and
granting access to the secure server if the transmitted authentication element corresponds to a stored authentication element for the user.

10. The method of claim 9 further comprising granting the user access to the authentication server and permitting the user to destroy the plurality of keys to prevent access to the user information stored on the secure server.

11. The method of claim 9 wherein the authentication element comprises a password.

12. A method for granting a user access to a secure computer system, the method comprising:
establishing a communications channel between the secure computer system and a first user device;
receiving an account identifier and a password from the first user device via the communications channel;
generating and transmitting a query from the secure computer system to the user to request an authentication element containing an encrypted code specific to the first user device and the account identifier;
retrieving a key stored by the computer system, wherein the key is specific to the first user device and account identifier, and wherein the key is adapted to allow decryption of the encrypted code;
receiving the authentication element and encrypted code from the first user device; and
granting access to the secure computer system only if the encrypted code received from the first user device, when decrypted with the key, corresponds to the account identifier and first user device.

13. The method of claim 12 wherein the secure computer system comprises a secured domain.

14. The method of claim 12 wherein the first user device comprises a personal computer.

15. The method of claim 12 further comprising refusing access to the secure computer system if the encrypted code received from the first user device, when decrypted with the key, does not correspond to the account identifier and first user device.

16. The method of claim 12 further comprising querying the user to transmit an updated code from the first user device, and replacing the encrypted code stored at the first user device with an updated encrypted code specific to the first user device.

17. The method of claim 12 further comprising:
establishing a communications channel between the secure computer system and a second user device;
receiving the account identifier and a password from the second user device via the communications channel between the secure computer system and second user device;
generating and transmitting a query from the secure computer system to the user to request an authentication element containing an encrypted code specific to the second user device and the account identifier;
retrieving a key stored by the computer system, wherein the key is specific to the second user device and account identifier, and wherein the key is adapted to allow decryption of the encrypted code;
receiving the authentication element and encrypted code from the second user device; and
granting access to the secure computer system only if the encrypted code received from the second user device, when decrypted with the key, corresponds to the account identifier and second user device.
